(19) United States
(12) Patent Application Publication
(10) Pub. No.: US 2021/0146634 A1
(43) Pub. Date: May 20, 2021

(54) THREE-DIMENSIONAL LOOP STRUCTURE BY ADDITIVE PRINTING

(71) Applicant: Aussco Hong Kong Limited, Kowloon (HK)

(72) Inventors: Jackson Hoi Fung CHOW, Hong Kong (HK); Marven Chi Chung CHICK, Hong Kong (HK)

(21) Appl. No.: 17/087,563

(22) Filed: Nov. 2, 2020

Related U.S. Application Data
(60) Provisional application No. 62/935,505, filed on Nov. 14, 2019.

(51) Int. Cl. B29C 64/40; B33Y 80/00

(52) U.S. Cl. CPC B29C 64/40; B33Y 10/00; B29K 2995/007; B33Y 80/00

(57) ABSTRACT

A three-dimensional printing loop and method for manufacturing an object out of a set of three-dimensional printing loops is provided herein. The printing loop has a loop head, loop legs, and loop feet for connecting to adjacent loops within a wale. The printing loops in a first wale may be interconnected with printing loops in a second wale. The resulting object can be printed using a three-dimensional printer and have elastic properties based on the physical characteristics of the printed loops interlocked as provided herein.

### CROSS-REFERENCE TO RELATED APPLICATIONS

This application claims the benefit of filing of U.S. Provisional Patent Application No. 62/935,505 filed on Nov. 14, 2019, which is incorporated by reference herein.

### BACKGROUND

Additive manufacturing (also popularly known as three-dimensional or 3D printing technology) is a computer controlled process for creating 3-D objects by depositing layers of materials on top of each other. The design is created based on a computer-aided design (CAD) model provided to the printer.

There are many different types of source materials available for 3D printing, including but not limited to ABS (acrylonitrile butadiene styrene), ASA (acrylostyrene acrylonitrile), PLA (polylactic acid), PET (polyethylene terephthalate), nylon, carbon fiber, polycarbonate, polypropylene, metal filaments, and wood filaments. Other materials may be used as dissolvable supports during the process. Dissolvable supports are printed during the printing process to support overhangs or other structures during manufacture and then are subsequently dissolved to be removed from the finished product. These materials include but are not limited to PVA (polyvinyl alcohol) and HIPS (high impact polystyrene, which may also be used as a primary source material). When used in 3D printing processes, most of these source materials result in hard objects with limited elongation under tensile stress. While flexible materials such as rubbers may be used in some 3D printing processes, these typically produce weak materials of limited industrial applicability. In addition, certain 3D printing processes such as polyjet may be used to produce softer final objects, but these resulting objects have weaker material strength. Therefore, a technical problem is that 3D printing materials and processes have limited ability to produce strong but flexible and/or stretchable objects.

One potential solution to this would be to adapt knitting techniques with interlocking loop structures to build a 2D or 3D object. Knitting takes a material (such as yarn) with limited elongation and allows the creation of a stretchable 2D fabric. A basic weft knit loop is shown in FIG. 1. The loop has a head (H) that interlocks with sinker loops in the wale above the head. The loop further has two legs (L) descending from the head. At the base of each leg of the loop is a foot (F) that swings outward to begin the next loop. The feet of adjacent loops form a sinker loop (S), through which the head of the loop in the wale below interlocks. Knitted fabrics permit large extension, particularly in the direction orthogonal to the orientation of the head loops (i.e., parallel to the wale). This makes them dimensionally unstable along the wales of the knit, that is, the object may be stretched substantially, and the deformation may be semi-permanent or permanent. In a 3D object such as that created by a 3D printer, this dimensional instability is even more acute.

What is needed then, is a new knit-like loop structure that can increase elongation in a 3D-printed object while maintaining the strength of the source material for the printed object, and which also maintains the dimensional stability of the object.

### DESCRIPTION OF DRAWINGS

FIG. 1 depicts a 2D weft knitting loop and the elements of the loop.

FIG. 2 depicts a 3D printing loop according to an embodiment of this disclosure.

FIGS. 3A and 3B depict two 3D printing loops interlocked together.

FIG. 4 depicts two layers of 3D printing loops interlocked together.

FIG. 5 depicts an array of 3D printed loops interlocked together.

FIG. 6 depicts two individual 3D loops according to an embodiment of the invention.

FIG. 7 depicts an array of large printed loops interlocked together.

### DETAILED DESCRIPTION

Disclosed herein is a loop structure creatable by 3D printers having three axes of elongation or stretchability using a rigid or inflexible material.

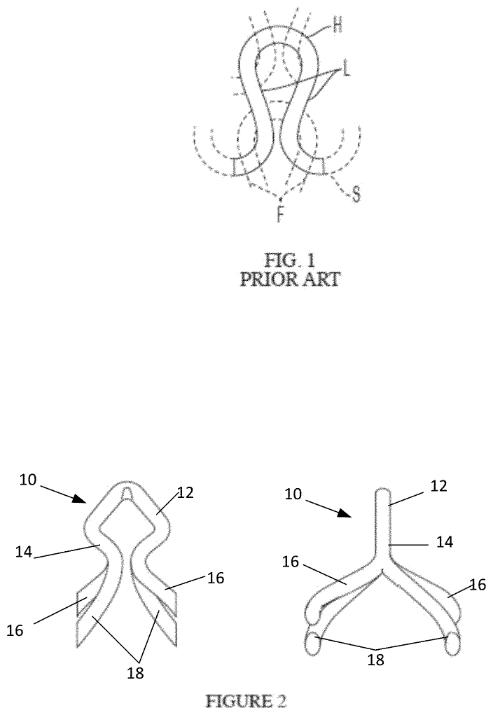

FIG. 2 depicts a 3D printing loop 10 according to an embodiment of the disclosure. The printing loop 10 is formed by a loop head 12 with two legs 14 and four feet 16 and 18. More specifically, the loop head 12 is the uppermost portion of the loop 10. The lower portion of the loop 10 is formed by two legs 14. Branching off from each leg 14 are two feet 16 and 18 extending generally radially outward and downward. The two feet 16 and 18 paired on a side have different lengths and heights so that they will not overlap. In some embodiments such as in FIG. 2, there is a lower foot 16 that has a more downward angle, and a higher foot 18 that has a less downward angle. Similarly, the two feet 16 and 18 paired on the other side may also be of different lengths and heights to provide a lower foot 16 and a higher foot 18. The feet 16 and 18 then join into the next adjacent loop 10, wherein the pattern may be repeated or varied, as further described herein.

In some embodiments, the loop structure may be formed by additively printing a selected source material and a selected dissolvable material in a manner that forms the interlocking loops and feet in situ. The source material is used to print the loops 10. Each layer of loops 10 forms a 2D wale 20 of loops 10, which may be interconnected with the printed feet 16 and 18 of the wale 20 of loops 10 above it. The loop head 12 of each loop 10 in the lower wale 20 is interconnected with two loop feet 16 and 18 descending from the loops 10 in the wale 20 above it. During the printing process, the loop head 12 of the loops 10 in the lower wale 20 may be supported by a dissolvable material that connects the loop head 12 to the two feet 16 and 18 of the loop head 10 in the upper wale 20 through which the lower loop head 12 connects. Once the dissolvable material is dissolved after printing, each wale 20 of loops 10 becomes separate, allowing for limited motion between the loops and the layered wales and providing an extendable or stretchable layer.

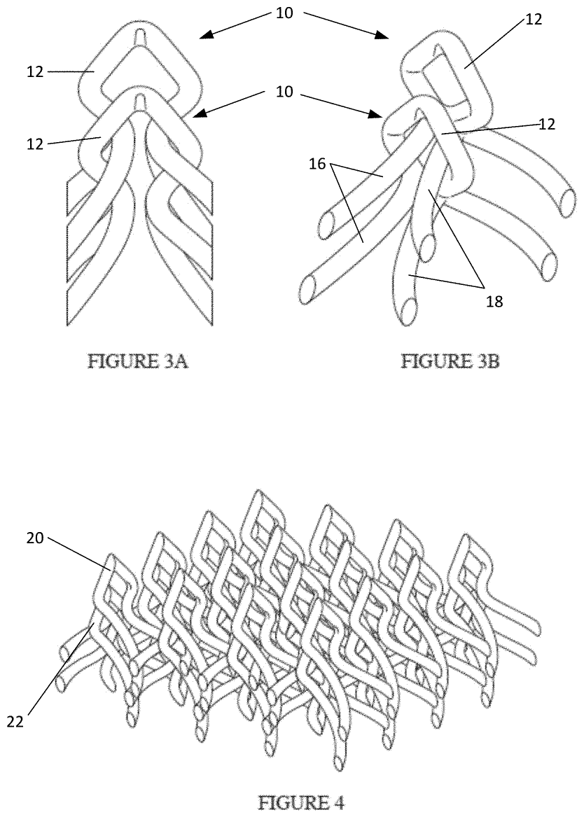

Thus, the two front feet 16 and 18 of a given loop 10 in the upper wale 20 will each pass through a loop 10 of the lower wale 20 that is in front of that given loop 10. Similarly, the two back feet 16 and 18 of the given loop 10 in the upper wale 20 will each pass through separate loops 10 of the lower wale that are behind and to either side of the given loop 10. An example of two interconnected loops 10 shown in isolation is provided in FIGS. 3A and 3B. An example of the finished layered construction using two layers of loops in a 10×5×2 unit array is shown in FIG. 4. In FIG. 4, the black loops are shown as the upper wale, and the gray loops are the lower wale. The gray loop heads 12 interconnect with the feet 16 and 18 of the black loops 10.

A loop 10 may further be defined by several parameters. The loop height is the distance from the top of the loop head to the bottom of the loop feet. The loop width is the distance from the end of one loop foot to an adjacent loop foot of the same loop along an x-axis. The loop depth is the distance from the end of one loop foot to an adjacent loop foot of the same loop in the y-axis, which is orthogonal to the x-axis. The foot length is the longitudinal length of each foot. The loop length is the total length of the printed loop material if laid out end to end. The loop length is equal to two times the loop height plus two times the loop leg lengths plus the length of the higher feet plus the length of the lower feet. The maximum elongation (i.e., stretchiness) of the resulting object created using this interlocking loop structure is correlated to the loop height; width, and depth. The maximum elongation percentage (%) along the x-axis is equal to the loop length minus the loop width, all divided by the loop width. The maximum elongation % on the y-axis is equal to the sum of the lengths of the higher feet and lower feet minus the loop depth, all divided by the loop depth. The maximum elongation % in the z-axis is equal to one-half of the loop length minus the loop height, all divided by the loop height. These equations are provided in algebraic form here:

Maximum elongation % on x-axis=(Loop Length−Loop Width)/Loop Width

Maximum elongation % on y-axis=((Length of higher feet+Length of lower feet)−Loop depth)/Loop depth

Maximum elongation % on z-axis=(½loop length−Loop height)/Loop height

Furthermore a longer loop leg length permits greater elongation, particularly in the z-axis (i.e., the axis running from head to feet). However, a longer loop leg length also requires additional dissolvable supporting material during printing to fill the larger volume of space between the loop legs. This increases printing time and cost.

The angles of the head, legs, and feet relative to a given axis may be designed to provide a “self-supporting” angle. In 3D printing, a self-supporting angle provides a structure that allows for the lower material to support the higher material during printing without the need for dissolvable supporting material to provide additional support during printing. If the angle is lower than the critical self-supporting angle, dissolvable supporting material is required to support the “overhanging” portion.

The loop thickness is the diameter of a cross-section of the loop head, i.e., the thickness of a single strand of printed material. The loop thickness is determined by the size of the nozzle of the printing machine. The loop thickness may be correlated to the maximum elongation percentage of the loops, and thereby also correlated to the maximum elongation percentage of the resulting object. For example, material having a Shore A hardness of 85 was tested for elongation percentage using the ASTM 5035 standard elongation test at a loop thickness of 1 mm and again at a loop thickness of 1.5 mm. The 1 mm loops had a maximum elongation percentage about 12% higher than the 1.5 mm loops. By means of such testing, a designer can select a particular material hardness and loop thickness and length to provide a desired maximum elongation percentage for the final produced object.

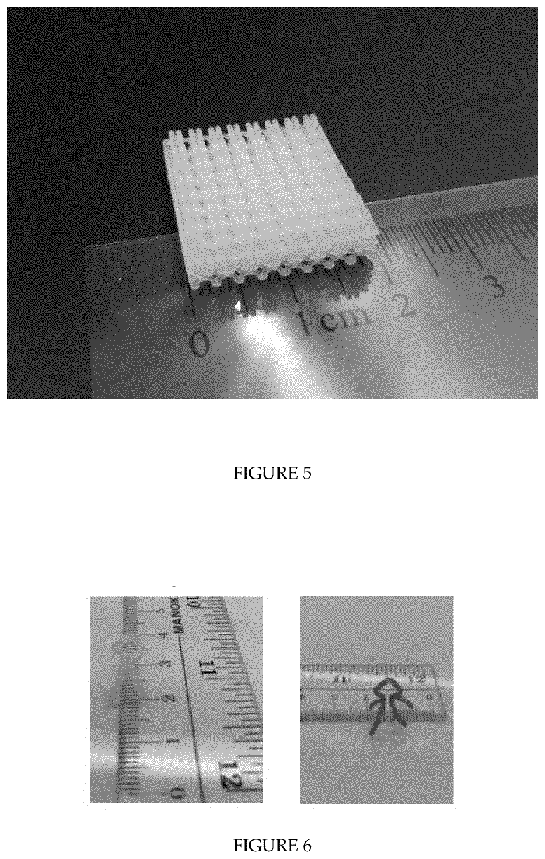

Some non-limiting exemplary embodiments of the printer loop are provided herein. In a first embodiment, an array of loops are manufactured together. Each loop has a thickness of 0.05 mm, and the array is approximately 2 centimeters square. Images of this embodiment are provided in FIG. 5.

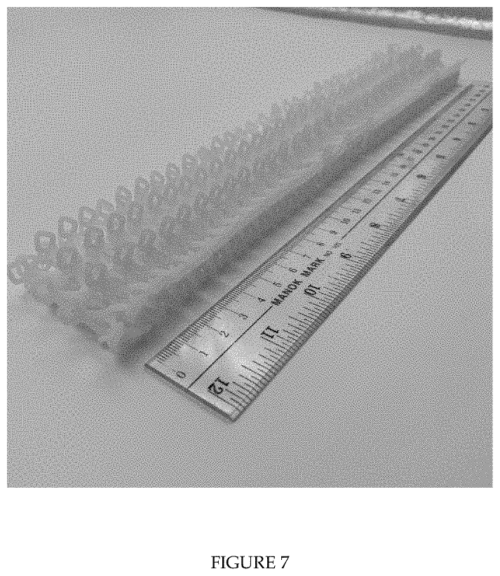

In a second embodiment, an array of loops having a loop width of 1.5 cm is provided, wherein the array has a width of approximately 25 centimeters. Images of this embodiment are provided in FIGS. 6 and 7. From these embodiments it is apparent that the size and configuration of the loop arrays forming an object can be of widely varying volume, material, loop thickness, loop hardness, loop length, loop width, and other physical characteristics.

The 3D printing loops disclosed herein provide technical solutions to problems in the prior art. For example, the 3D printing loop can be manufactured from a high-hardness, high-strength material while also permitting the resulting object to have higher tensile elongation than if the object were made solidly from the same material.

Furthermore, the multi-feet 3D printing loop provides tensile elongation in all three Cartesian directions for the object.

Furthermore, the maximum amount of elongation permissible in any given direction can be designed based on the geometric specifications of the 3D printing loop. This removes the problem of indeterminate elongation common in 2D knitted structures based on yarn.

Furthermore, the object can be formed of loops in variable sizes and thicknesses, thereby providing customizable elongation for specific parts of the object. This may be desired where elongation is preferable in some parts of the printed object but not in others.

Other benefits and embodiments may be realized by those of ordinary skill in the art without departing from the scope of this disclosure.

We claim:

1. A 3D printing loop comprising: a loop head, two loop legs descending from the loop head, and two loop feet descending from each loop leg.

2. The printing loop of claim 1, wherein each loop leg connects to an adjacent 3D printing loop.

3. The printing loop of claim 1, wherein the printing loop is formed of a material having a Shore A hardness of 85.

4. The printing loop of claim 1, wherein the printing loop has a thickness of 1 mm.

5. The printing loop of claim 1, wherein the printing loop has a thickness of 1.5 mm.

6. The printing loop of claim 1, wherein the printing loop has a thickness of 0.05 mm.

7. The printing loop of claim 1, wherein the printing loop has a loop width of 1.5 cm.

8. An object comprising a first wale of 3D printing loops and a second wale of 3D printing loops interlocked with the 3D printing loops of the first wale, each 3D printing loop comprising a loop head, two loop legs descending from the loop head, and two loop feet descending from each loop leg, wherein the head of a 3D printing loop in the second wale is interlocked with two legs of a 3D printing loop in the first wale.

9. The object of claim 8, wherein the printing loops are formed of a material having a Shore A hardness of 85.

10. The object of claim 8, wherein the printing loops have a thickness of 1 mm.

11. The object of claim 8, wherein the printing loops have a thickness of 1.5 mm.

12. The object of claim 8, wherein the printing loops have has a thickness of 0.05 mm.

13. The object of claim 8, wherein the printing loops have a loop width of 1.5 cm.

14. The object of claim 8 wherein the printing loops are not uniform in thickness.

15. The object of claim 8, wherein the printing loops are not uniform in loop height.

16. The object of claim 8, wherein the printing loops are not uniform in loop width.

17. A process for manufacturing an object using a 3D printer, comprising:
additively printing a first 3D printing loop and a second 3D printing loop, each 3D printing loop comprising a loop head, two loop legs descending from the loop head, and two loop feet descending from each loop leg, wherein the head of the second 3D printing loop is interlocked with two legs of the first 3D printing loop, and further wherein the first 3D printing loop is connected to the second 3D printing loop by dissolvable material; and
dissolving the dissolvable material.
